(19) United States
(12) Patent Application Publication
(10) Pub. No.: US 2010/0054559 A1
(43) Pub. Date: Mar. 4, 2010

(54) IMAGE GENERATION BASED ON LIMITED DATA SET

(75) Inventor: Manoj Narayanan, Eindhoven (NL)

Correspondence Address: PHILIPS INTELLECTUAL PROPERTY & STANDARDS, P. O. Box 3001, BRIARCLIFF MANOR, NY, 10510, US

(73) Assignee: KONINKLIJKE PHILIPS ELECTRONICS N. V., Eindhoven (NL)

(21) Appl. No.: 12/515,539

(22) PCT Filed: Nov. 20, 2007
(86) PCT No.: PCT/IB2007/054711

§ 371 Date: Nov. 11, 2009

Related U.S. Application Data
(60) Provisional application No. 60/866,862, filed on Nov. 22, 2006.

(51) Int. Cl. G06K 9/00

(52) U.S. Cl. 382/128

(57) ABSTRACT

A method, signal processor, device, and system for estimating a parametric or functional image 47 mapping a biological process on the basis of a limited or incomplete sequence of biological process images 40 recorded as a function of time, e.g. by a PET or SPECT scanner after injection of a radio tracer. One or more kinetic parameters 43 are first extracted by applying a pharmacokinetic model 42 (compartmental model of the underlying tracer kinetics) to the sequence of biological process images 40. Additional data 41 are used in the model, comprising at least a predetermined kinetic parameter range (e.g. from the literature), and optionally an input function or a blood clearance function. Next, an iterative algorithm 44 is applied to arrive at a modified sequence of images 45, e.g. by inserting an estimated image into the incomplete sequence of images, utilizing the one or more kinetic parameters 43. After a stop criterion has been fulfilled, the resulting image 47 is finally estimated 46 from the modified sequence of images 45. The method can be used e.g. to estimate a hypoxia parameter k₃ image in the case of a FMISO data set where only late-time images are available. The method may be implemented as part of existing PET, SPECT, CT, MR or Ultrasound scanner software, and since only a limited amount of late time post injection images are necessary to provide a reliable result, the method helps to increase patient comfort and clinical throughput.

### FIELD OF THE INVENTION

The present invention relates to the field of generating images mapping a biological process, such as that used within clinical medical applications to assist therapy and diagnosis. More specifically, the invention provides a method, a signal processor, a device, and a system for generating an image that maps a biological process and that is to be used in combination with an output unit of a scanner for mapping tracer kinetics. Especially, the invention is capable of providing an image based on a limited or incomplete set of data, such as an incomplete time sequence of images of a biological process.

### BACKGROUND OF THE INVENTION

Molecular imaging modalities such as positron-emission tomography (PET) and single-photon emission tomography (SPECT) are unique in employing radioactively labeled biological molecules as tracers for studying and visualizing pathophysiological mechanisms in vivo. In principle, functional imaging modalities would allow early visualization of disease processes, since anatomical changes (such as a change in tumor size) usually lag behind the pathological response.

Both PET and SPECT scanners can generate dynamic images of regional radiopharmaceutical uptake, permitting regional measurements of tracer kinetics. Tracer kinetics are usually estimated on the basis of compartmental models. The resulting parameters estimated from a time series of dynamic PET or SPECT images can be used to characterize or quantify many aspects of biological processes such as inter alia cell proliferation, cell death, drug delivery, and tumor hypoxia.

One issue with acquiring four dimensional (4D) dynamic scans is the prolonged acquisition times, which may amount to 3 hours in some cases (e.g. 18F-FMISO for PET hypoxia imaging). In order to improve clinical throughput as well as patient comfort, therefore, images are acquired a certain time after injection of the radio tracer.

An example would be FDG (fluorodeoxyglucose) images acquired 1 hour after injection. These late-time images, which represent the tracer distribution at a particular point in time, while useful may not convey the entire picture. Another alternative would be to measure a smaller subset of points in time. Investigators have looked into dual time point imaging with FDG in order to differentiate between malignant tumor lesions and inflammatory sites, see e.g. [H. Zhuang, M. Pourdehnad, E. S. Lambright, A. J. Yamamoto, M. Lanuti, P. Li, P. D. Mozley, M. D. Rossman, S. M. Albelda, and A. Alavi, “Dual Time Point 18F-FDG PET Imaging for Differentiating Malignant from Inflammatory Processes”, J Nucl Med 2001; 42:1412-1417]. However, many of the tracers employed in PET and SPECT to probe biological processes display complex tracer kinetics, necessitating the need for pharmacokinetic modeling and analysis.

### SUMMARY OF THE INVENTION

Hence, it is an object to provide a method capable of generating an image that maps a biological process and is based on a limited or incomplete set of biological process images recorded as a function of time. In other words, the method must be capable of providing a reliable image, such as a parametric image, mapping an underlying biological process on the basis of an image sequence with missing data.

This object and several other objects are achieved in a first aspect of the invention by providing a method of estimating an image that maps a biological process on the basis of a sequence of two or more biological process images recorded as a function of time, the method comprising the steps of:

extracting at least one kinetic parameter by applying a pharmacokinetic model to the sequence of two or more biological process images by taking into account additional data comprising at least a predetermined kinetic parameter range,

applying an iterative algorithm to arrive at a modified sequence of biological process images based on the at least one kinetic parameter,

estimating the image that maps the biological process on the basis of the modified sequence of biological process images.

Based on an input sequence of only a limited amount of biological process images, the method is capable of providing an image, such as a parametric, functional or molecular image, that maps the underlying biological process. Thus, for example, given only a few late-time tracer uptake images from a scanner, the method can be used to estimate reliably a parametric image which is close to the corresponding parametric image that would have been derived had the entire time sequence of images been available. The method thus renders it possible to increase patient comfort since the patient only needs to be scanned for a limited period of time in a dynamic scanning sequence after injection of a radio tracer or contrast agent, rather than having to spend a long time in the scanner in order to record a complete sequence of images covering a long period of time.

By extracting or estimating a kinetic parameter, or a set of kinetic parameters, obtained as a result of applying a pharmacokinetic model, the method is capable of generating a modified sequence of images comprising a number of images that is increased with respect to the input sequence of images. The pharmacokinetic model is then iteratively applied to the modified sequence of images, and yet further images can be estimated. In order to provide a proper initiation of the iterative algorithm, the pharmacokinetic model takes into account a predetermined kinetic parameter range, e.g. based on relevant data from the literature. In addition, the pharmacokinetic model may further take as its input an input function related to the biological process. Such an input function may comprise data representing a blood clearance curve.

In an implementation, the sequence of two or more biological process images is a sequence of tracer kinetic images, and a pharmacokinetic model comprises analyzing tracer kinetics using a compartmental model so as to extract the at least one kinetic parameter. Thus, the biological process mapped by the image may be described by transport rate constants and parameters describing the compartmental model. Such a compartmental model may be a 2-, 3-, 4- or 5-compartment model.

In one specific embodiment, the compartmental model is a two-compartment fluoromisonidazole (FMISO) kinetic model, and the iterative algorithm comprises optimizing K₁, k₂, k₃ and β parameters of the two-compartment FMISO kinetic model. In an implementation, the biological process of tissue hypoxia mapped by the generated parametric image is described by a transport rate constant of a two-compartment FMISO kinetic model.

The method is suitable for processing biological process images resulting from tracer kinetic scanning, such as radiotracer kinetic scanning, the scanning images being recorded by a scanner such as: CT, MR, PET, SPECT, and Ultrasound scanners.

In an embodiment, the iterative algorithm comprises repeating the steps of:

generating at least one estimated image based on the at least one kinetic parameter, and

extracting at least a modified kinetic parameter by applying the pharmacokinetic model to the modified sequence of biological process images comprising the at least one estimated image,

until a predetermined stop criterion is met.

The stop criterion may be based on a threshold value indicative of an achieved quality of the resulting image. The stop criterion may be met when, for example, a root mean square distance between successive iterates is less than the threshold value. Alternatively, the stop criterion may be based on a predetermined number of iterations performed.

It is appreciated that any two or more of the above-mentioned embodiments or sub-aspects of the first aspect may be combined in any way.

In a second aspect, the invention provides a signal processor arranged to estimate an image that maps a biological process on the basis of a sequence of two or more biological process images recorded as a function of time, the signal processor comprising:

a kinetic parameter extractor arranged to extract at least one kinetic parameter by applying a pharmacokinetic model to the sequence of two or more biological process images by taking into account additional data comprising at least a predetermined kinetic parameter range,

an image estimator arranged to apply an iterative algorithm to arrive at a modified sequence of biological process images based on the at least one kinetic parameter, and

an image generator arranged to estimate the image that maps the biological process on the basis of the modified sequence of biological process images.

The signal processor may be implemented either as a dedicated signal processor or as a general purpose signal processor, such as in a computer or computer system, with an appropriate executable program. The signal processor may be a digitally based signal processor based on one single chip processor or split into several processor chips.

It is to be appreciated that the same advantages and the same embodiments as mentioned for the first aspect apply for the second aspect as well.

In a third aspect, the invention provides a device comprising a signal processor according to claim 10. The device may be a computer or a computer system, such as a main frame computer or a stand alone computer. The device may comprise a display monitor for displaying at least the resulting image that maps the biological process. In an implementation, the device comprises an interface, either wired or wireless, for receiving a record image or a sequence of images from a scanner, e.g. a PET or SPECT scanner.

It is to be appreciated that the same advantages and the same embodiments as mentioned for the first aspect apply equally to the third aspect.

In a fourth aspect, the invention provides a system comprising:

a scanner arranged to record a sequence of two or more biological process images as a function of time,

a signal processor according to claim 10, the signal processor being operationally connected to the scanner for receiving the sequence of two or more biological process images recorded as a function of time, and

a display operationally connected to the signal processor for displaying the image mapping the biological process.

As mentioned above, the scanner may be a PET, SPECT, CT, MR, or an Ultrasound machine, or any of the types mentioned above in connection with the first aspect. Furthermore, it is to be appreciated that the same advantages and the same embodiments as mentioned for the first aspect apply equally to the fourth aspect.

In a fifth aspect, the invention provides a computer executable program code adapted to perform the method according to the first aspect. As mentioned, such a program may be executed on dedicated signal processors or on general-purpose computing hardware. It is to be appreciated that the same advantages and the same embodiments as mentioned for the first aspect apply for the fifth aspect as well.

In a sixth aspect, the invention provides a computer readable storage medium comprising a computer executable program code according to the fifth aspect. A non-exhaustive list of storage media comprises: a memory stick, a memory card. a CD, a DVD, a Blue-ray disk, or a hard disk, e.g. a portable hard disk. It is to be appreciated that the same advantages and the same embodiments as mentioned for the first aspect apply equally to the sixth aspect.

It is noted that advantages and embodiments mentioned for the first aspect also apply to the second, third, fourth, fifth, and sixth aspects of the invention. Thus, it is appreciated that any one aspect of the present invention may be combined with any of the other aspects.

### BRIEF DESCRIPTION OF THE FIGURES

The present invention will now be explained, by way of example only, with reference to the accompanying Figures, where

FIG. 1 illustrates a device embodiment according to the invention,

FIG. 2 illustrates a flowchart of a first implementation of the method,

FIG. 3 illustrates a 2-compartment FMISO model, and

FIG. 4 illustrates a flowchart of second implementation of the method.

### DETAILED DESCRIPTION OF EMBODIMENTS

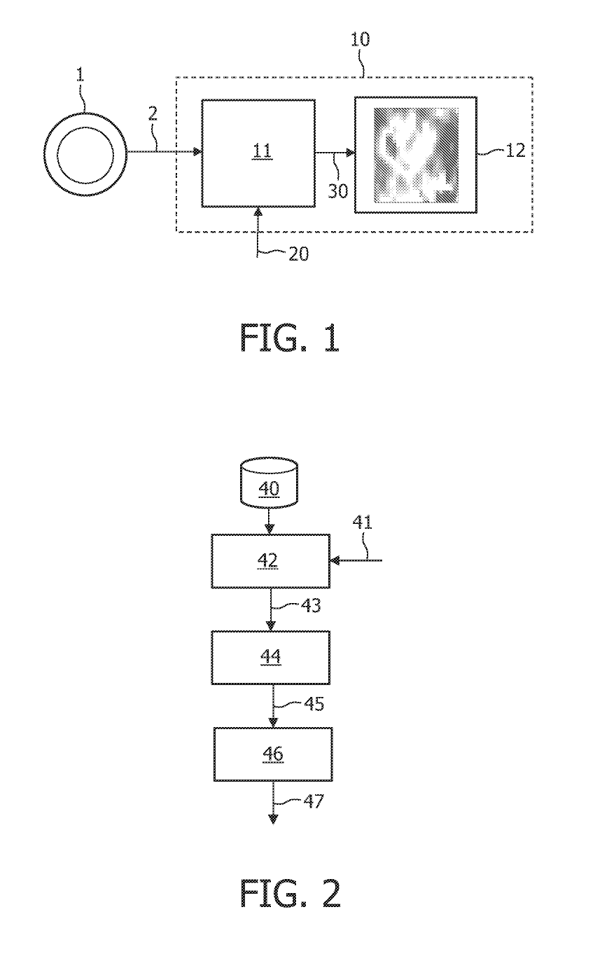

FIG. 1 illustrates a device 10 arranged for operation in connection with a scanner 1, e.g. a PET scanner, which can record a sequence of images 2 as a function of time, or data representing such images 2. The sequence of images 2 represents a scanning of a regional part of a human body after injection of a radio tracer or contrast agent. The sequence of images 2 may represent, for example, FMISO data with missing time points. It may be that images in a particular time range (e.g. 0-90 minutes) after injection are missing. The incomplete sequence of images 2 is then processed by a signal processor 11, either directly from the scanner 1 or after being stored. The signal processor 11 also receives additional data 20, such as literature-based data regarding a kinetic parameter range, and optionally an input function, such as blood clearance functional data. The signal processor 11 then performs an iterative algorithm on the data 2, 20 comprising the application of a pharmacokinetic model in an iterative algorithm, as will be explained in detail later. The signal processor 11 then estimates a parametric or functional image 30 that maps the underlying biological process, for example tissue hypoxia with the k₃ parameter estimated from an FMISO data set. The image 30 data are then transferred to a display screen 12 that can visualize the image 30, for example as a 2D image representing the scanned regional part of the human body using colors to visualize the parameter values.

FIG. 2 is a flowchart of a first implementation of the method. A sequence of biological process images 40 recorded as a function of time are substituted in a pharmacokinetic model 42 together with additional data 41 that at least comprise a predetermined kinetic parameter range, for example a value based on the literature. The additional data 41 may also comprise an input function or a blood clearance function. The pharmacokinetic model 42 is used to extract or estimate one or more kinetic parameters 43 (e.g. K₁, k₂, k₃ and β in case of FMISO data) based on the sequence of images available 40 and the additional data 41. Next, an iterative algorithm 44 is applied to the sequence of images 40, taking into account the one or more kinetic parameters 43 to update and re-apply the pharmacokinetic model and estimate missing images in the sequence of images so as to arrive at a modified sequence of images with more images. In the next iteration, the pharmacokinetic model is applied to the modified sequence of images, thus arriving at a modified or updated kinetic parameter. This iterative algorithm 44 is then repeated until a suitable stop criterion is met. Finally, the resulting modified sequence of images 45 is used in a process of estimating 46 an image 47 mapping the biological process.

Several different stop criteria may be applied in the iterative algorithm 44; for example, one stop criterion may follow from a comparison of the resulting image 47 with the image based on the previous iteration, and when a difference between the resulting image 47 and the image based on the previous iteration is below a predetermined threshold value, the iteration is stopped, and the last estimated image 47 is then outputted. Otherwise, the iteration is continued.

The pharmacokinetic model 42 mentioned in the foregoing and other details relating to the method illustrated by FIG. 2 will be described in more detail in the following sections.

A number of static scans or a contiguous time series of dynamic scans is recorded when devices such as CT (Computed Tomography), MR (Magnetic Resonance), PET (Positron Emission Tomography), SPECT (Single Photon Emission Computed Tomography), or US (Ultrasound) systems are used for displaying functional or morphological properties of a patient under study. To obtain the medical information of interest encoded in these images, a kinetic analysis of the underlying chemical, biological, and physiological processes has to be carried out in certain applications.

Compartmental modeling is based on a special type of mathematical model for the description of the observed data, in which physiologically separate pools of an imaging agent (also called tracer substance) are defined as “compartments”. The model then describes the concentration of said imaging agent in the different compartments, for example in the compartment of arterial blood on the one hand and in the compartment of tissue on the other hand (it should be noted, however, that in general compartments need not be spatially compact or connected). Typically, there is an exchange of substance between the various compartments that is governed by differential equations with (unknown) parameters like exchange rates. In order to evaluate a compartment model for a given observation, the differential equations have to be solved and their parameters have to be estimated such that the resulting solutions optimally fit to the observed data. More details on the technique of compartmental analysis may be found in the literature (e.g. S. Huang and M. Phelps, “Principles of Tracer Kinetic Modeling in Positron Emission Tomography).

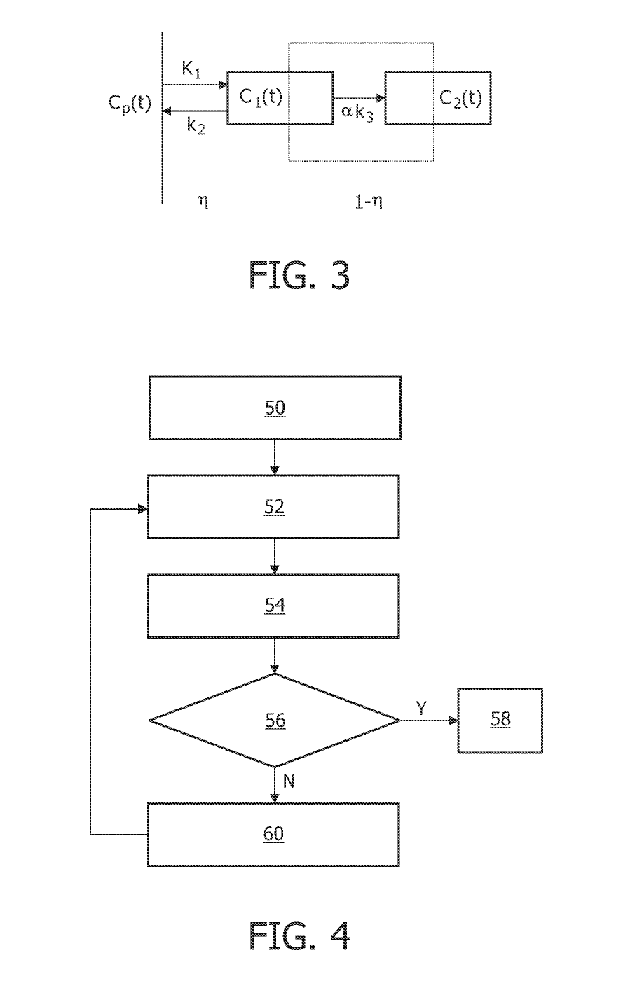

FIG. 3 illustrates a 2-compartment model as an example of the modeling of FMISO kinetics for analyzing the underlying tracer kinetics and arriving at the relevant biological parameters of interest, which in this case are parameters describing tissue hypoxia. In this model α is the branching fraction, η the extra-cellular fraction, and K₁, k₂ and k₃ are the transport rate constants characterizing the model. C₁ and C₂ indicate the two compartments, and the blood clearance curve as a function of time t is denoted Cₚ(t). The rate constant k₃ describes the reduction and further metabolism of the [¹⁸F]FMISO molecule and is used as a measure of hypoxia since it is inversely proportional to the oxygen concentration.

Normally, 4D dynamic image acquisitions are obtained in a scanning period starting from the time of injection of a radiotracer until equilibration of tracer occurs between plasma and tissue compartments. Thus, this entire period is normally divided into a number of time points, such as equidistant time points, and a complete set of images includes an image associated with each time point. If the acquired set of images consists of images associated with only a subset of time points of the entire scanning period, pharmacokinetic modeling (or compartmental modeling) is challenging since, in order to arrive at meaningful solutions for compartmental models characterizing a particular tracer, a number of factors need to be considered. These factors comprise not the estimation of the kinetic parameters characterizing a particular model but also the estimation of missing image data (PET or SPECT distribution data in time). According to the invention, this is overcome by carefully incorporating prior knowledge in terms of e.g. kinetic parameter ranges observed physiologically from published animal and human studies and by estimating missing image data iteratively.

FIG. 4 is a flowchart of a second implementation of the method, comprising a step of estimating the kinetic parameter of interest for a dynamic sequence of images, e.g. a FMISO sequence of images. For this embodiment it is assumed that the input function or the blood clearance curve (Cₚ in FIG. 3) is available. The input function may be obtained by collecting arterial samples (or venous samples) at predetermined intervals over the complete time-activity distribution period. These collected samples are assessed for radioactivity by means of specialized counters so as to form the input function curve. In view of the invasive nature of this procedure, alternative methods of estimating the input function are also available. These comprise non-invasive image-based input functions as well as population mean based blood-input curves (see e.g. [A B. Olshen, F O. Sullivan, “Camouflaged deconvolution with Application to blood curve modeling in FDG PET studies”, J. Amer. Stat. Assoc., vol. 92, no. 440, pp 1293-1303, 1997]).

The flowchart of FIG. 4 comprises a first step 50 of generating a modified sequence of images by replacing missing values with a suitable starting value, such as replacing missing values with the mean value (within the missing time interval) of the input function (or a scaled version of the input function). In step 52, a compartmental model is applied to the modified sequence of images to estimate kinetic parameters (e.g. K1, k2, k3 and β for FMISO optimization). The estimated kinetic parameters are constrained in that judiciously chosen initial conditions and parameter ranges are used (typically chosen from published reports on animal or human studies for a particular tracer). In step 54, an estimated error of the kinetic parameters may be calculated. In a decision step 56, it is verified whether the estimated error satisfies a stop criterion, e.g. whether the estimated error is below 5%. If the answer is ‘yes’ Y, then the next step is step 58 for stopping the iteration, and thus the current kinetic parameters can be used to produce an output image. If the answer is ‘no’ N, the next step is step 60 for modifying the data set by including estimated data at those time points where data is missing, The estimated data are computed on the basis of the kinetic parameters from the compartmental model obtained in step 52. Hence, in step 60, images not available at certain time points are estimated from time-activity curves predicted by the compartmental model. After performing step 60, the algorithm jumps back to step 52, and the compartmental model is now applied to the modified data set comprising the estimated data obtained in step 60. The algorithm of FIG. 4 thus describes an iterative estimation which is repeated until a suitable stop criterion is reached.

An example of an estimated error is the root-mean square distance between successive iterates of model parameters. This root-mean square distance computed in step 54 at the n^{th} iteration may be defined as:

$$E = \frac{1}{2} {\sum }_{k} \sqrt{( {k}^{( n )} - {k}^{( n - 1 )} )}$$

where the sum runs over parameters k of the compartmental model, N is the number of parameters, and k⁽ⁿ⁾ and k⁽ⁿ⁻¹⁾ denote values of a model parameter k at the n^{th} and (n−1)^{st} iteration.

As an illustration, the method has been tested in a lung cancer FMISO study where the parameter of interest k₃ is used to quantify hypoxic sub-volumes in the tumor. The complete 4D FMISO data set consisted of a sequence of 33 images (time frames) acquired from 0 to 240 minutes post-injection of FMISO. In order to simulate the case of missing data, only a few late time images where taken as input to the method, the first 29 images were discarded, and the k₃ images were estimated by the procedure explained above. A comparison of the resulting k₃ image based on the incomplete data set in the method according to the invention and the k₃ image calculated from the entire data set revealed only insignificant differences, i.e. unimportant as regards a medical interpretation of the image. In conclusion, it has been verified that the method is capable of saving much scanning time since it only requires a limited amount of image data to provide a reliable result.

The invention may be implemented as part of PET, SPECT, MR, CT or Ultrasound imaging software for pharmacokinetic modeling of tracer kinetics of radiotracers or contrast agents if the complete time sequence of scanning images is not available for a variety of reasons, such as long acquisition times (which is tracer-dependent), patient comfort considerations, and faster clinical throughput. Estimation of kinetic parameters characterizing regional tracer kinetics is expected to play a key role in the understanding of many disease processes (cell proliferation, programmed cell death, angiogenesis, hypoxia, tumor resistance, etc.). The ability to estimate these parametric images even from incomplete data is expected to play a key role in tracking patient response to therapy across serial scans (in the course of therapy) as well as in integrating pharmacokinetic modeling within the clinical workflow. In addition, it may also be applied to improve target definition for radiation therapy by incorporating biological information provided by parametric images.

To summarize, a method, signal processor, device, and system are provided for estimating a parametric or functional image 47 that maps a biological process on the basis of a limited or incomplete sequence of biological process images 40 recorded as a function of time, e.g. by a PET or SPECT scanner after injection of a radio tracer. One or more kinetic parameters 43 are first extracted through the application of a pharmacokinetic model 42 (compartmental model of the underlying tracer kinetics) to the sequence of biological process images 40. Additional data 41 are used in the model, comprising at least a predetermined kinetic parameter range (e.g. from literature), and optionally an input function or a blood clearance function. Next, an iterative algorithm 44 is applied to arrive at a modified sequence of images 45, e.g. by introducing an estimated image into the incomplete sequence of images, utilizing the one or more kinetic parameters 43. After a stop criterion has been fulfilled, the resulting image 47 is finally estimated 46 from the modified sequence of images 45. The method may be used e.g. to estimate a hypoxia parameter k₃ image in the case of a FMISO data set where only late-time images are available. The method may be implemented as part of existing PET, SPECT, CT, MR or Ultrasound scanner software, and since only a limited amount of late-time post injection images are necessary to provide a reliable result, the method helps to increase patient comfort and clinical throughput.

Although the present invention has been described in connection with the specified embodiments, it is not intended to be limited to the specific form set forth herein. Rather, the scope of the present invention is limited only by the accompanying claims. In the claims, the term “comprising” does not exclude the presence of other elements or steps. Additionally, although individual features may be included in different claims, these may possibly be advantageously combined, and the inclusion in different claims does not imply that a combination of features is not feasible and/or advantageous. In addition, singular references do not exclude a plurality. Thus, references to “a”, “an”, “first”, “second” etc. do not preclude a plurality. Furthermore, reference signs in the claims shall not be construed as limiting the scope.

1. Method of estimating an image (47) that maps a biological process on the basis of a sequence of two or more biological process images (40) recorded as a function of time, the method comprising the steps of:
extracting at least one kinetic parameter (43) by applying a pharmacokinetic model (42) to the sequence of two or more biological process images (40) by taking into account additional data (41) comprising at least a predetermined kinetic parameter range,
applying an iterative algorithm (44) to arrive at a modified sequence of biological process images (45) based on the at least one kinetic parameter (43), and
estimating (46) the image (47) that maps the biological process on the basis of the modified sequence of biological process images (45).

2. Method according to claim 1, wherein the iterative algorithm (44) comprises repeating the steps of:
generating at least one estimated image on the basis of the at least one kinetic parameter (43), and
extracting at least a modified kinetic parameter by applying the pharmacokinetic model to the modified sequence of biological process images comprising the at least one estimated image,
until a predetermined stop criterion is met.

3. Method according to claim 1, wherein the biological process is tracer kinetics.

4. Method according to claim 1, wherein the additional data (41) further comprise an input function related to the biological process.

5. Method according to claim 4, wherein the input function related to the biological process comprises data representing a blood clearance curve.

6. Method according to claim 1, wherein the sequence of two or more biological process images (40) is a sequence of tracer kinetic images recorded by a scanner selected from the group comprising: Computed Tomography, Magnetic Resonance, Positron Emission Tomography, Single Photon Emission Computed Tomography, and Ultrasound.

7. Method according to claim 1, wherein the sequence of two or more biological process images (40) is a sequence of tracer kinetic images, and wherein a pharmacokinetic model (42) comprises analyzing tracer kinetics using a compartmental model so as to extract the at least one kinetic parameter (43).

8. Method according to claim 7, wherein the biological process mapped by the image (47) is described by transport rate constants and by parameters of the compartmental model.

9. Method according to claim 8, wherein the compartmental model is a two-compartmental fluoromisonidazole kinetic model, and wherein the iterative algorithm (44) comprises optimizing K₁, k₂, k₃ and β parameters of the two-compartment fluoromisonidazole kinetic model.

10. Method according to claim 1, wherein the image mapping a biological process (47) is selected from the group comprising: parametric images, functional images, and molecular images.

11. Signal processor (11) arranged to estimate an image (30) that maps a biological process on the basis of a sequence of two or more biological process images (2) recorded as a function of time, the signal processor (11) comprising:
a kinetic parameter extractor arranged to extract at least one kinetic parameter by applying a pharmacokinetic model to the sequence of two or more biological process images by taking into account additional data (20) comprising at least a predetermined kinetic parameter range,
an image estimator arranged to apply an iterative algorithm so as to arrive at a modified sequence of biological process images on the basis of the at least one kinetic parameter, and
an image generator arranged to estimate the image (30) that maps the biological process on the basis of the modified sequence of biological process images.

12. Device (10) comprising a signal processor (11) according to claim 11.

13. System comprising:
a scanner (1) arranged to record a sequence of two or more biological process images (2) as a function of time,
a signal processor (11) according to claim 11, the signal processor (11) being operationally connected to the scanner (1) for receiving the sequence of two or more biological process images (2) recorded as a function of time, and
a display (12) operationally connected to the signal processor (11) for displaying the image (30) that maps the biological process.

14. Computer executable program code adapted to perform the method according to claim 1.

15. Computer readable storage medium comprising a computer executable program code according to claim 14.
